(19) United States
(12) Patent Application Publication
(10) Pub. No.: US 2003/0207077 A1
(43) Pub. Date: Nov. 6, 2003

(54) Automotive trim components having aesthetic features

(76) Inventors: Keith A Riha, Rochester, MI (US); Jeffrey A Rose, Harrison Township, MI (US)

Correspondence Address: Steven J Grossman, Grossman Tucker Perreault & Pfleger, 55 South Commercial Street, Manchester, NH, 03101, US

(21) Appl. No.: 10/221,225

(22) PCT Filed: Mar. 8, 2001
(86) PCT No.: PCT/US01/07463

(51) Int. Cl. B32B 3/10

(52) U.S. Cl. 428/120; 428/137

(57) ABSTRACT

An automotive trim component (10) is provided which enables an aesthetic feature (26) of a trim component (10) to be observed by a vehicle occupant when the aesthetic feature (26) is viewed by the vehicle occupant through a portion of the trim component (32).

This invention relates to automotive trim components having aesthetic features and, more particularly, aesthetic features which may be observed by vehicle occupants who view through a portion of the trim component.

In the automotive field, efforts have been made to improve on the aesthetic and visual experience for the vehicle occupant. Traditionally, such efforts focus on new designs and styling which vary color patterns and the way interior components may be positioned relative to one another. In addition, efforts have been made to make more efficient use of internal vehicle space and the development of, e.g., additional storage compartments in those sections of the vehicle that were previously under-utilized.

One area of interior vehicle styling that has been somewhat overlooked has been the development of the visual perceptions of the occupants to create a more spacious concept of the cockpit interior. That being the case, the present invention seeks to address this issue as explained more fully below.

According to one aspect of the present invention, an automotive trim component is provided which enables an aesthetic feature of a trim component to be observed by a vehicle occupant when the aesthetic feature is viewed by the vehicle occupant through a portion of the trim component.

According to another aspect of the invention, an automotive interior trim component is provided comprising a first layer having an outer surface and an inner surface, a second layer comprising at least one rib adjacent the inner surface of the first layer, wherein the rib is visible through the first layer when viewed by a vehicle occupant.

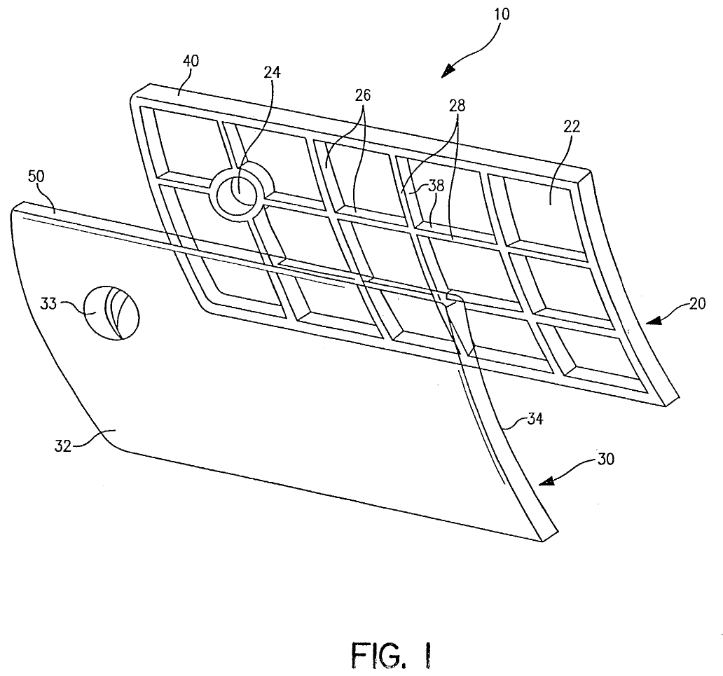

FIG. 1 is an exploded view of a trim component according to the present invention;

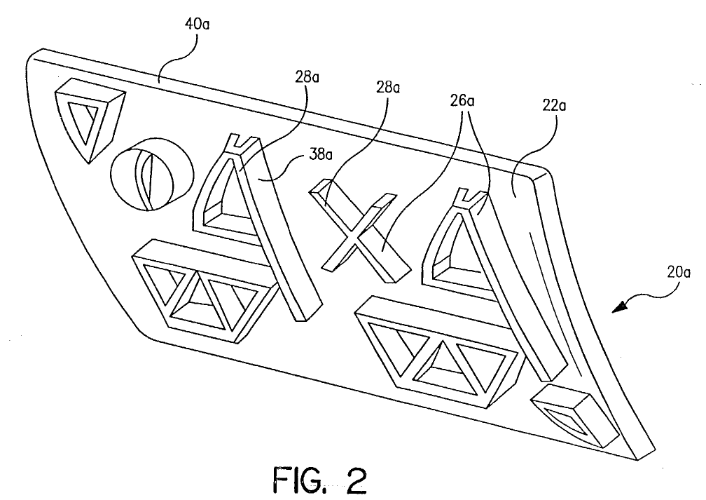

FIGS. 2-4 are perspective views of various alternative embodiments of the present invention.

An exemplary automotive interior trim component is illustrated at 10 in FIG. 1. As shown, trim component 10 is a glove box door, but may comprise any other trim component including, but not limited to, console lids, storage compartment lids, instrument panel bezels and steering column covers.

Trim component 10 comprises a first member 20 and a second member 30. First member 20 comprises ribs 26. Second member 30 comprises outer surface 32, inner surface 34, and is constructed from a translucent or transparent material. Second member also contains an aperture section 33. Ribs 26 are preferably adjacent the inner surface 34 of second member 30. As a result, ribs 26 of first member 20 are visible to vehicle occupants who view from outer surface 32 through second member 30. The ribs 26 are configured to present an aesthetic styling feature when observed by vehicle occupants.

Ribs 26 are preferably supported on a base 22. Base 22 may include one or more apertures 24 to provide a vehicle occupant a view through the base, such as into a storage compartment located behind the base 22. Apertures 24 are preferable made to align with aperture 33 of second member 30. Base 22 may include a perimeter edge 40 for joining first member 20 to second member 30 as discussed in greater detail below. Alternatively, where a base 22 is not used and ribs 26 are provided solely, a vehicle occupant may view into the storage compartment merely by viewing between ribs 26.

As shown in FIG. 1, ribs 26 may be parallel, transverse or create one or more box structures. In other embodiments, as shown in FIGS. 2-4, ribs 26 may comprises any number of geometric shapes (e.g. circles, squares, rectangles, triangles, trapezoids), lettering (e.g. “X”), numbering (e.g. “4”) or symbols (e.g. “4×4”). Still, in other embodiments not shown, ribs may comprise an identity such as a manufacture's name, a manufacturer's logo, a vehicle make, a vehicle model, a vehicle accessory, a vehicle logo, a trademark or other alphanumeric and symbolic shapes. Preferably, ribs 26 function as a structural element and provide an elevated level of structural integrity or energy management when a force, such as an vehicle occupant's knee, is applied to the outer surface 32 of second member 30 during a vehicle impact or collision as compared to where ribs 26 are not utilized.

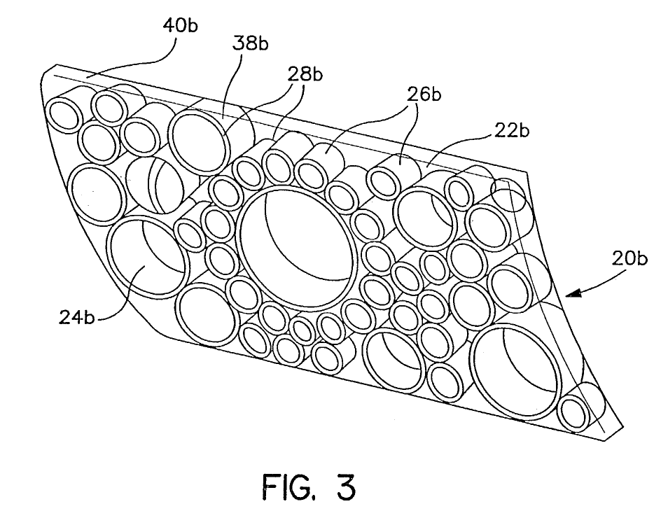

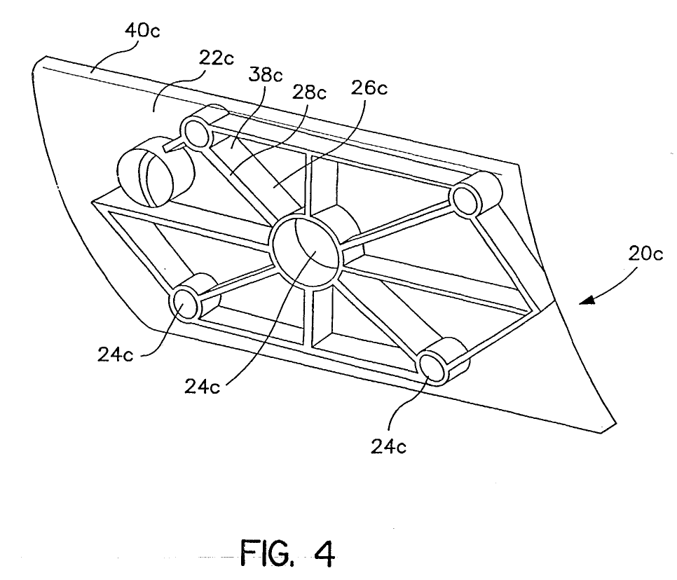

More specifically, with attention directed to FIG. 2, it can be seen that first member 20a comprises base 22a and a perimeter edge 40a. First member 20a contains, e.g., rib structures 26a. Also shown are outer surface rib edges at 28a. Side surface of one of the exemplary ribs is shown at 38a. Attention is next directed to FIG. 3 which shows first member 20b comprising base 22b and perimeter edge 40b. First member 20b contains, e.g., rib structures 26b which as illustrated form a plurality of apertures 24b. Such apertures then can be made to align with one or a plurality of apertures on second member 30 (see FIG. 1). Also shown are outer surface rib edges at 28b. Side surface of one of the exemplary ribs is shown at 38b. Attention is next directed to FIG. 4 which shows first member 20c comprising base 22c and perimeter edge 40c. First member 20c contains, e.g., rib structures 26c. Also shown are outer surface rib edges at 28c. Side surface of one of the exemplary ribs is shown at 38c. Apertures can be seen at 24c.

It can be appreciated that the invention herein provides a vehicle occupant with a three-dimensional view, through second member 30, of the aesthetic features identified above. That is, by virtue of the aesthetic features having a depth as identified by side surface 38, the image transmitted to the viewers takes on depth and three-dimensional appearance. Furthermore, by virtue of the three-dimensional appearance being beneath second member 30, the three-dimensional image viewed by a vehicle occupant is further enhanced.

First member 20 is preferably formed from a thermoplastic material, but may be made from any polymer material. The thermoplastic material for first member 20 may be translucent, transparent, or opaque. Further, the thermoplastic material may include a colorant, such as a pigment or a dye. Examples of materials include, but are not limited to, polycarbonate, polypropylene, acrylonitrile-butadiene-styrene, polyester, and polyurethane. First member 20 is preferably formed by injection molding. Other forming techniques may include injection-compression molding, compression molding, thermoforming, vacuum forming, pressure forming, blow molding, slush molding and casting.

Second member 30 is preferably also formed from thermoplastic material, but may be made from any polymer material. The thermoplastic material for second member 30 may be translucent or transparent. Further, the thermoplastic material may include a colorant, such as a pigment or a dye. Examples of materials include, but are not limited to polycarbonate, acrylic, polysulphone, nylon, polystyrene, poly-methyl-1-pentene, polyvinylchloride and polyethylene terepthalate. Second member 30 is preferably formed by injection molding. Other forming techniques may include injection-compression molding, compression molding, thermoforming, vacuum forming, pressure forming, blow molding, slush molding and casting.

Following the forming of members 20 and 30, they are joined preferably along at least a portion of their perimeter edges 40, 50 in the instance where base 22 is used. Preferred methods of joining members 20 and 30 include, but are not limited to, vibration welding, ultrasonic welding, adhesive bonding, solvent bonding, thermal welding, thermal bonding, and mechanical fastening.

Upon joining first member 20 and second member 30, outer surface rib edge 28 of first member 20 is preferably in contact with, and more preferably joined to, the inner surface 34 of second member 30. As shown in FIG. 1, both outer surface perimeter edge 42 and outer surface rib edge 28 have the same planar height relative to outer surface 22 of first member 20.

Alternatively, a sequential two-step injection molding process may be used to produce trim component 10. When produced using a sequential injection molding process, ribs 26 of the first member 20 are preferably formed from a colored thermoplastic material injected into a first mold cavity comprising the shape of ribs 26. The mold is then adjusted to provide a second mold cavity comprising the shape of the second member 30. Second member 30 is then formed from a transparent or translucent thermoplastic material injected into the second mold cavity. Preferably, the inner surface 34 of the second member 30 bonds to outer surface rib edge 28. Alternately, second member 30 may be formed first, and the ribs 26 of the first member 20 may be formed thereafter.

Alternately, trim component 10 may be formed as a unitary construction, wherein ribs 26 project from inner surface 34 of second member 30. Preferably trim component 10 is formed using a single shot injection molding process, wherein transparent or translucent plastic material is injected into a cavity defining second member 30 having ribs 26 projecting from inner surface 34.

We intend the above description to illustrate embodiments of the present invention by using descriptive rather than limiting words. Obviously, there are many ways that one might modify these embodiments while remaining within the scope of the claims. In other words, there are many other ways that one may practice the present invention without exceeding the scope of the claims herein.

We claim:

1. A component for a motor vehicle comprising:
a second member overlying a first member;
the second member having an outer surface, an inner surface and comprising a transparent or translucent plastic material;
the first member comprising at least one or a plurality of ribs observable to a vehicle occupant through the second member, said one or a plurality of ribs comprising a side surface and an outer surface;
said one or a plurality of ribs function to increase rigidity of said first member.

2. The component of claim 1 wherein the first member further comprises a base, the rib projecting from the base towards the inner surface of the second member.

3. The component of claim 2 wherein said base of said first member further comprises an aperture and said second member comprises an aperture, said first member aperture aligned with said aperture of said second member.

4. The component of claim 3 wherein said one or plurality of ribs on said first ember are connected to said first member aperture.

5. The component of claim 1 wherein the rib outer surface is in contact with the second member inner surface.

6. The component of claim 1 wherein the rib outer surface is joined to the second member inner surface.

7. The component of claim 1 wherein the rib outer surface is joined to the second member inner surface by at least one of the group comprising vibration welding, ultrasonic welding, adhesive bonding, solvent bonding, thermal welding, thermal bonding, and mechanical fastening.

8. The component of claim 1 wherein the first member and the second member each comprise a perimeter edge with the first member and the second member joined along at least a portion of the perimeter edges.

9. The component of claim 1 wherein the rib comprises at least a portion of a geometric shape selected from the group consisting of circles, squares, rectangles, triangles, trapezoids, lettering, numbering, symbols, trademarks, and mixtures thereof.

10. The component of claim 1 wherein the component comprises a storage compartment lid.

11. The component of claim 1 wherein the storage compartment lid covers a storage compartment, and contents of the storage compartment observable to a vehicle occupant through the second member.

12. A component for a motor vehicle comprising:
a second member overlying a first member;
the second member having an outer surface, an inner surface and comprising a transparent or translucent plastic material;
the first member comprising at least one or a plurality of apertures wherein said apertures provide viewing there-through by a vehicle occupant.

13. The component of claim 12 wherein said second member comprises one or a plurality of apertures.

14. A component for a motor vehicle comprising:
a plastic member comprising a transparent or translucent material and having an outer surface and an inner surface, the plastic member having at least one rib extending from the inner surface, the ribs observable to a vehicle occupant; wherein said rib functions to increase rigidity of said plastic member.

15. The component of claim 14 wherein said ribs comprise a geometric shape selected from the group consisting of circles, squares, rectangles, triangles, trapezoids, lettering, numbering, symbols, trademarks and mixtures thereof.
